(19) United States
(12) Patent Application Publication
(10) Pub. No.: US 2017/0123800 A1
(43) Pub. Date: May 4, 2017

(54) SELECTIVE RESOURCE ACTIVATION BASED ON PRIVILEGE LEVEL

(71) Applicant: International Business Machines Corporation, Armonk, NY (US)

(72) Inventors: Giles R. Frazier, Austin, TX (US); David A. Larson Stanton, Rochester, MN (US)

(21) Appl. No.: 14/931,938

(22) Filed: Nov. 4, 2015

(51) Int. Cl. G06F 9/30

(52) U.S. Cl. CPC G06F 9/30123; G06F 9/30058

(57) ABSTRACT

Prevention of “context-changing interrupts” (see definition, below) and/or “performance-affecting interventions” (see definition, below) to be made with respect to a newly-dispatched program before the relevant control registers associated with the program have been initialized. This can be especially helpful in systems where control registers are not initialized until the newly-dispatched program needs to use a facility and/or resource that requires initialization of the control registers.

### BACKGROUND OF THE INVENTION

The present invention relates generally to the fields of computer program privilege levels and computer resource activation and/or deactivation.

A control register is a processor register which changes or controls the general behavior of a CPU or other digital device (a “CPU or other digital device,” which is capable of interrupting a program and/or being used by a program, is sometimes referred to herein as a “facility” or a “resource”). Tasks typically performed by control registers include interrupt control, switching the addressing mode, paging control, and/or coprocessor control.

A hypervisor is a module (see definition, below) formed by computer software, firmware and/or hardware that creates and runs virtual machines. Typically, computers running one or more virtual machines are defined as being a host machine. In turn, each virtual machine is called a guest machine. The hypervisor typically presents the guest operating systems with a virtual operating platform. The hypervisor also manages the execution of the guest operating systems. Herein, the operating system (OS) may sometimes be referred to as a “supervisor,” where a hypervisor may handle several supervisors.

A privilege level controls the resources and instruction set available to the program currently running on the processor. The resources controlled by the privilege level typically relate to components such as memory regions, I/O ports, performance monitors, and special instructions (for example, a floating point resource built into a central processing unit). Typical privilege levels have a range from 0 (which is the most privileged level) to 3 (which is the least privileged level), but there may be variations to these levels (now known and/or to be further developed in the future). For example, many systems include 3 privilege levels referred to as hypervisor level (most privileged), supervisor level (medium privilege), and application level (least privileged).

### SUMMARY

According to an aspect of the present invention, a method, computer program product and/or system is used with a computer system including a plurality of resources and a processor(s) set including a plurality of control registers. The a method, computer program product and/or system includes the following actions (not necessarily in the following order) and/or machine readable data for causing these actions to be performed: (i) starting to run a program; (ii) in response to starting to run the program, controlling initialization of control registers of the plurality of control registers that are associated with the program so that at least some of the control registers do not immediately initialize in direct response to the starting of the running of the program; (iii) receiving, from a first resource of the plurality of resources, an attempt to make a context-changing interrupt with respect to the program; (iv) determining whether the attempted context-changing interrupt by the first resource would involve control registers associated with the program that have not been initialized; and (v) in response to a determination that the attempted context-changing interrupt would involve control registers that have not been initialized, preventing, by machine logic, the attempted context-changing interrupt from proceeding.

According to an aspect of the present invention, a method, computer program product and/or system is used with a computer system including a plurality of resources and a processor(s) set including a plurality of control registers. The a method, computer program product and/or system includes the following actions (not necessarily in the following order) and/or machine readable data for causing these actions to be performed: (i) starting to run a program; (ii) in response to starting to run the program, controlling initialization of control registers of the plurality of control registers that are associated with the program so that at least some of the control registers do not immediately initialize in direct response to the starting of the running of the program; (iii) subsequent to the control of initialization of control registers so that at least some of the control registers do not immediately initialize, initializing the at least some of the control registers; and (iv) controlling, by machine logic included in a processor(s) set, a first facility included in the processor(s) set so that the first facility does not attempt to make a performance-affecting intervention in the running of the program until after initialization of the at least some of the control registers, with a performance-affecting intervention being defined as any “intervention” which: (a) does not change the order of execution of instructions of the program, and (b) does impact performance of the program.

### BRIEF DESCRIPTION OF THE DRAWINGS

FIG 1A is a block diagram view of a first embodiment of a system according to the present invention;

FIG. 1B is a another block diagram showing another portion of the first embodiment of a system according to the present invention;

FIG. 1C is another block diagram showing another portion of the first embodiment of a system according to the present invention; and FIG. 2 is a flowchart showing a method performed by the first embodiment system; and

FIG. 2 is a flowchart showing a method performed by the first embodiment system.

### DETAILED DESCRIPTION

Some embodiments of the present invention prevent “context-changing interrupts” (see definition, below) and/or “performance-affecting interventions” (see definition, below) to be made with respect to a newly-dispatched program before the relevant control registers associated with the program have been initialized. This can be especially helpful in systems where control registers are not initialized until the program needs to use a facility and/or resource that requires initialization of the control registers.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

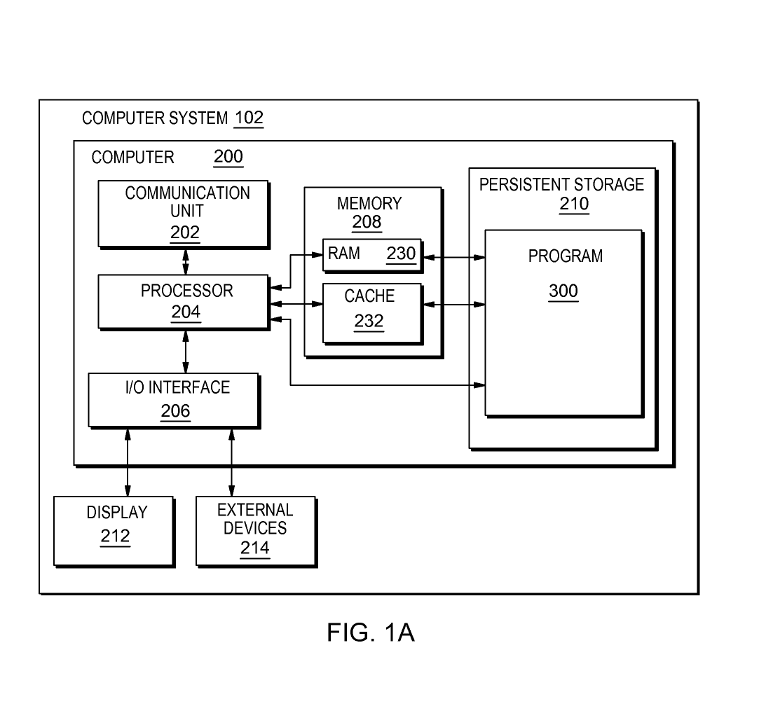

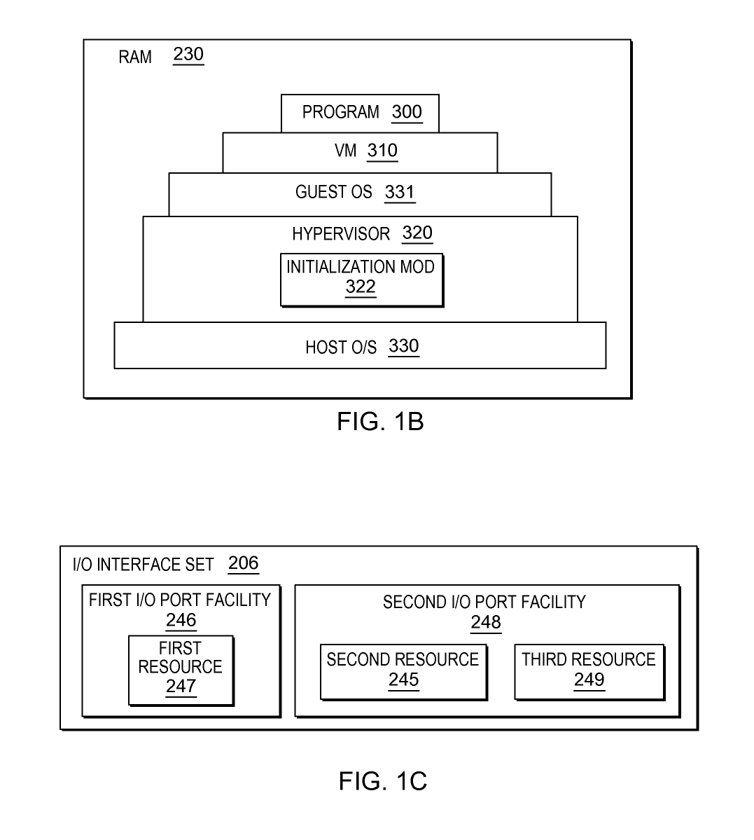

An embodiment of a possible hardware and software environment for software and/or methods according to the present invention will now be described in detail with reference to the Figures. FIG. 1A is a functional block diagram illustrating computer system 102, including: computer 200; communication unit 202; processor set 204 (including control registers, not separately shown); input/output (I/O) interface set 206; memory device 208; persistent storage device 210; display device 212; external device set 214; random access memory (RAM) devices 230; cache memory device 232; and program 300.

System 102 is, in many respects, representative of various computer system(s) that can be used in connection with the present invention. Accordingly, several portions of system 102 will now be discussed in the following paragraphs. System 102 may be a laptop computer, tablet computer, netbook computer, personal computer (PC), a desktop computer, a personal digital assistant (PDA), a smart phone, or any programmable electronic device. Program 300 is a collection of machine readable instructions and/or data that is used to create, manage and control certain software functions that will be discussed in detail, below, in the Example Embodiment sub-section of this Detailed Description section.

System 102 is shown as a block diagram with many double arrows. These double arrows (no separate reference numerals) represent a communications fabric, which provides communications between various components of computer-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for system 102; and/or (ii) devices external to system 102 may be able to provide memory for system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

As shown in FIG. 1C, I/O interface set includes first I/O port facility 246; first resource 247; second I/O port facility 248; second resource 245 and third resource 249. I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

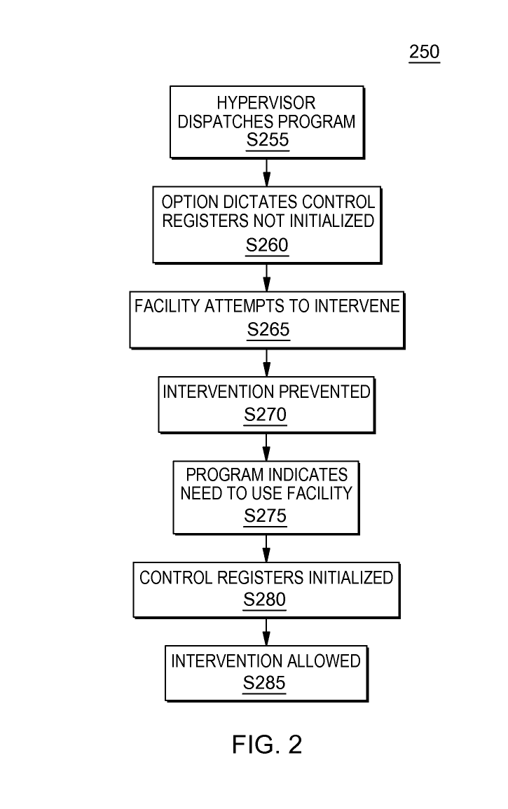

FIG. 2 shows flowchart 250 depicting a method according to the present invention. FIGS. 1A, 1B and 1C shows various software and/or hardware functional blocks for performing at least some of the method steps of flowchart 250. This method and associated software will now be discussed, over the course of the following paragraphs, with extensive reference to FIG. 2 (for the method step blocks) and FIGS. 1A, 1B and 1C (for the hardware and/or software blocks).

Processing begins at operation S255, where hypervisor 320 and/or guest VM 310 dispatches program 300 to run on virtual machine (VM) 310. As shown in FIG. 1B, VM 310 is run on guest OS 331, which guest OS is run on hypervisor 320. Operation S255 may be performed in any manner currently conventional or to be developed in the future.

Processing proceeds to operation S260, where initialization module (“mod”) 322 of hypervisor 320 determines that an option has been selected so that control registers associated with program 300 are not initialized. Alternatively and/or additionally, initialization mod 322 could be implemented in guest OS 331 and/or processor set 204 (see FIGS. 1A and 1B). More specifically, control registers in processor set 204 are not initialized (for example “zeroed”) in direct response to the instantiation of program 300. Initialization mod 322 also allows for an option where the control registers are initialized in direct response to instantiation of a new program, but method 250 deals with cases where control registers are not immediately initialized. Delaying the initializing of the control registers can help avoid latencies, delays and the like upon the starting of an instance of a program.

Processing proceeds to operation S265, where third resource 249 of second port I/O facility 248 of I/O interface set 206 attempts to “intervene” (see definition, below, in the definitions sub-section of this Detailed Description section) with respect to the operation of program 300. More specifically, third resource 249 attempts to make a “context-changing interrupt” (see definition, below) type of intervention with respect to the operation of program 300. This attempted context-changing interrupt may be made in any manner that is currently conventional, or, to be developed in the future. In this example, the facilities and resources separately shown in the drawings are limited, as shown in FIG. 1C, to: first I/O port facility 246 (including first resource 247); and second I/O port facility 248 (including second resource 245 and third resource 249). However, as will be understood by those of skill in the art, and, as mentioned above: (i) there may be facilities and resources in other locations in the system, other than I/O interface set 206; and (ii) a single facility may have one, a few or many resources included in it.

In the example of system 102 and method 250 under discussion, all facilities and resources are shown in connection with I/O interface 206 for pedagogical reasons. However, it should be understood that, in various different embodiments, the facilities and/or resources, which are prevented from intervening, may be found in many different components of computer system 102, other than I/O-related components. For example, a “garbage collection” facility may attempt to interrupt when the program attempts to access a certain area of memory. When the facility has not yet been made available to the program and not initialized, machine logic control according to the present invention is used to prevent it from intervening too. In various embodiments, some facilities may be internal to the processor.

Processing proceeds to operation S270, where an intervention prevention module (not separately shown in the drawings) present in processor(s) set 204 prevents the attempted intervention from going forward. This prevention is helpful because the control registers (in processor(s) set 204 and associated with program 300) are not registered yet, so any intervention could lead to unfavorable side effects. Preventing the intervention prevents the unfavorable side effects. In other examples, where selected option(s) dictate that the control registers associated with program 300 are immediately initialized upon starting up program 300, resource intervention(s) may be allowed after initialization of the relevant control registers.

In this example of method 250, no control registers associated with program 300 are initialized in direct response to instantiation of program 300, and, accordingly, no interventions by any resources are allowed, at the time of operations S265 and S270, by any resource. Alternatively, there may be embodiments where: (i) some control registers are immediately initialized in direct response to instantiation of program 300 while other control registers are not initialized; (ii) resources that use only the initialized control registers are allowed to intervene by the intervention prevention mod in the processor(s) set; and (iii) resources that use uninitialized control registers prevented from intervening by the intervention prevention mod in the processor(s) set. In other words, the hypervisor may initialize registers and enable usage of and intervention by a subset of registers and disable usage of and intervention by another subset.

Types of intervention which can be prevented by various embodiments of the present invention will now be discussed in more detail. The two types of intervention which can be prevented are: (i) “context-changing interrupts;” (see definitions, below, of “interrupt” and “context-changing interrupt”); and (ii) “performance-affecting intervention.” In the example of operation S270, and as mentioned above, the type of intervention attempted and prevented is a context-changing interrupt. Alternative and/or additionally, various embodiments may also prevent performance-affecting interventions. More specifically, performance affecting interventions are “prevented” by making machine logic in the processor that: (i) determines whether relevant control registers in the processor(s) set for a program have yet been initialized; and (ii) if they have not been initialized then no performance-affecting intervention is made with respect to the program. A specific example of this, involving a potential performance-affecting intervention by a data stream control register (DSCR) will be discussed, below, in the Further Comments and/or Embodiments sub-section of this Detailed Description section.

Processing proceeds to operation S275, where program 300 indicates a need to use first resource 247 of facility 246 of I/O interface set 206. This indication may be made in anyway currently conventional, or to be developed in the future. An example of such an indication is an attempt to access a register of the facility. When this attempt occurs, the hypervisor is interrupted.

Processing proceeds to operation S280, where, in response to the indication of operation S275, initialization mod 322 of hypervisor 320 causes all control registers associated with program 300 to be initialized. Alternatively, in some embodiments, initialization mod 322 may cause initialization only of some of the control registers associated with program 300, specifically only the control registers required for program 300 to use first resource 247. The hypervisor need not initialize registers not required by the program, such as registers of the facility that are only accessible to the hypervisor.

Processing proceeds to operation S285 where program 300 is allowed to use first resource 247, and intervention prevention mod will generally allow interventions by the resources of the system with respect to program 300.

III. Further Comments and/or Embodiments

Some embodiments of the present disclosure prevent certain resources of a facility from interrupting execution of machine readable instructions and/or making changes to hardware behavior. As an example of an illustrative example of facility, a floating point facility typically includes resources such as instructions and control registers. This prevention of interruption of software execution and/or changes to hardware behavior prevents deficiencies from being introduced. For example, the floating point facility may have certain controls that are defective, and changes to hardware behavior resulting from their settings may need to be prevented. In some embodiments of the present invention, a performance monitor facility is prevented from causing supervisor interrupts to occur when the performance monitor facility is inaccessible to a supervisor even though registers of the performance unit indicate that a supervisor interrupt should occur. As a further example, in some embodiments, the DSCR (data stream control register) resource is prevented from affecting the behavior of data cache control instructions, even if the DSCR, itself, is made unavailable to the data cache control program. In this example embodiment, the contents of the DSCRs cannot affect processor behavior. In other words, disabling supervisor access prevents the DSCRs from causing unwanted effects on the supervisor. As those of skill in the art will appreciate, the foregoing examples involving DSCR & floating point are examples of modification of processor behavior as opposed to prevention of intervention. The performance monitor example involves prevention of intervention.

In some embodiments, the disabling of certain abilities in a resource, which would otherwise have those abilities, allows a hypervisor to restore a supervisor in a way that: (i) does not require first initializing the registers of the resources to their default values; and (ii) avoids unwanted side-effects, thereby decreasing the amount of time required to restore (that is, dispatch) the program. In some embodiments, eliminating the need to “zero,” or initialize, the registers enables the hypervisor to restore the supervisor faster.

Some embodiments of the present invention may include one, or more, of the following features, characteristics and/or advantages: (i) when swapping in a supervisor that is not using the performance monitor, the contents of the registers do not have to be cleared prior to activating the supervisor, thus unexpected performance monitor interrupts cannot occur; (ii) eliminating the need to clear the registers significantly increases performance because the need to write to multiple performance monitor registers during context swap operations is eliminated; (iii) eliminates multiple register write operations because access to the performance monitor registers is disabled along with disabling their side effects (for example, unexpected performance monitor interrupts and subsequent errors); (iv) enables hypervisors, or any program of a higher privilege level, to disable access to a facility by programs of lower privilege level; (v) removes the requirement for the higher privilege program to initialize the contents of the registers associated with unused facilities during context swaps; and/or (vi) significantly increases performance.

Some embodiments of the present invention extend the scope of current facility access controls to include the control over the effects of those controls. The types of effect that might be controlled, under various embodiments, are numerous in number and various in nature. The types of effect that might be controlled include control over: program interruptions; instruction behaviors; and/or other operating parameters.

The types of facilities, prevented for taking certain actions under various embodiments, are also numerous in number and various in nature. The types of facilities prevented from taking certain actions may include: performance monitors; data cache instructions; debug facilities; messaging facilities; and/or any other facility which contains registers that can affect the behavior of the processor.

Some embodiments of the present invention can be implemented using registers that contain fields corresponding to each facility, as shown below in the table of example facility availability registers:

| | | | |
|---|---|---|---|
| Facility 1 | Facility 2 | . . . | Facility N |

The above table of facility availability registers contains one field for each facility that is to be controlled, where each field may consist of a single bit if the entire facility is to be controlled, or multiple bits where subsets of each facility are to be controlled individually. There is one of these registers for each privilege level. The hypervisor register HFSCR (hypervisor facility status and control register) controls the availability of facilities to privileged programs and applications, and the “facility availability register” controls the availability of facilities to applications. When the bit in the field corresponding to a particular facility is set to 1, the facility is available, otherwise the facility is not available to the privilege level(s) that the register controls (that is, supervisors and applications for the HFSCR and applications for the FSCR (facility stream control register)).

In some embodiments of the present invention, in addition to controlling the availability of registers and instructions provided by the facility, each bit also controls the availability of all processor behaviors that the facility can enable. Some examples showing this are as follows: (i) if the facility controlled is a performance monitor, then making the performance monitor unavailable also disables performance monitor interrupts from occurring, even if the contents of the performance monitor control registers would otherwise enable interrupts; (ii) if the facility is the DSCR (data stream control register), then all data cache control instructions behave as if the register contained all zeroes (the default values) regardless of the DSCR contents; (iii) if the facility is the debug facility, then making the debug facility unavailable also disables trace and data storage interrupts from occurring regardless of the state of the CIBR (completed instruction breakpoint register) or the DEAW (data effective address watchpoint) register; and/or (iv) if the facility is the privileged message send instruction and register, then making this facility unavailable also disables directed privileged doorbell interrupts from occurring regardless of the state of the DPDES (directed privileged doorbell exception state) register.

In some embodiments of the present invention, any facility that can enable side effects, such as interrupts or changes in processor behavior, can also be controlled by fields in the FSCR and HFSCR or similar register.

Is some embodiments, the primary advantage of the present invention is to eliminate the need for the supervisor and hypervisor to load the registers corresponding to any of the facilities controlled during the context swap operation. Instead, the registers can be loaded after the program has attempted to access the facility and the corresponding “facility unavailable” interrupt has occurred, or not load the registers at all if no access attempt is made. In the case of the DSCR, and, as mentioned above, the DSCR does not cause interrupts but it only affects processor behavior. So if an embodiment made it always available to the program but only made its contents ineffective, then the hypervisor will never be interrupted due to its usage. In this case, the hypervisor may enable its contents to become effective at some later time. Because many facilities contain a large number of registers, this scheme can significantly increase the performance of context swap operations. Time consuming register loads may be avoided entirely if the facility is not used, or the overhead of restoring the registers can be distributed as each access attempt is made rather than being performed all at once during the initial context swap operation.

Some embodiments of the present invention may include one, or more, of the following features, characteristics and/or advantages: (i) eliminates the need to restore control registers for a facility during a context swap; (ii) eliminates the need to restore control registers for a facility during initial program dispatch; (iii) eliminates the need to clear control registers for a facility while still ensuring that the facility does not generate an interrupt; (iv) prevents interrupts that may be generated from a facility that is unavailable to a privilege level from affecting that privilege level without clearing the control registers; (v) prevents an inaccessible facility from generating an interrupt to a particular privilege level even though the interrupt is enabled; (vi) prevents the interrupt from occurring regardless of whether it is disabled or not; (vii) enables the facility to be left in an undefined state, after a context swap operation, without the need to disable the interrupt; (viii) eliminates the need to clear control registers during a context swap; (ix) does not require routing of the interrupts that would affect the program being restored; (x) does not require routing of the interrupts that would disable the interrupts entirely; and/or (xi) allows the control registers to remain in an undefined state.

Some embodiments of the present invention may include one, or more, of the following features, characteristics and/or advantages: (i) isolation of programs executing at a selectable privilege level of a processor from any effects of an otherwise-active facility; (ii) prevents a facility from interrupting, or otherwise interfering with, programs at a given privilege level; (iii) prevents a hypervisor from clearing all control registers related to a set of facility(ies) when dispatching a program at a given privilege level; (iv) reduces overhead associated with unneeded, and/or untimely, clearing of control registers; (v) eliminates side effect(s) on a running program at a selectable privilege level by eliminating the clearing of control registers at a time of program dispatch; (vi) when the program at a selectable privilege level may need to use the facility, it allows the control registers to be left in an undefined state when the program is first dispatched; (vii) when the program later begins to use the facility, the hypervisor is interrupted and the registers can be restored; (viii) this ability to delay the initialization of a facility, until the facility is actually used, potentially results in significant performance improvement because it allows the overhead of program dispatch to be spread out over time; and/or (ix) eliminates the need to initialize the facility if the program is pre-empted before attempting to use the facility.

In some conventional computer systems, the hypervisor and supervisor include controls that can enable an interrupt to occur whenever a lower-privileged program attempts to use a facility. For example, one conventional computer system provides a bit in a Hypervisor Facility Status and Control Register (HFSCR) that causes an interrupt to occur if an application attempts to access the Vector facility. In response to the interrupt, the controlling machine logic can either deny the access, or enable the access to occur by setting the bit corresponding to the Vector facility in the HFSCR. Other bits in the HFSCR provide similar functions for other facilities. A deficiency in the above scheme is introduced when the facility being controlled has side-effects such as causing interrupts or changing hardware behavior. For example: (i) a Performance Monitor facility can cause supervisor interrupts to occur even if it is inaccessible to a supervisor; and (ii) the Data Stream Control register (DSCR) can affect the behavior of data cache control instructions even if the register, itself, is made unavailable to the program. Because the contents of these registers can affect processor behavior, simply disabling supervisor access to them does not prevent them from causing unwanted effects on the supervisor. This inability to disable the effects of a facility results in the inability of the hypervisor to restore a supervisor that does not require access to the facility without first initializing the registers to their default values for which there are no unwanted side-effects. (Such a process is sometimes referred to as “lazy zeroing” the registers because the registers only need to be initialized after the hypervisor is interrupted when they are first used.)

Some embodiments of the present invention disable side effects of selected multiple facilities, including interrupts, effects on performance or other processor behaviors in addition to simply disabling only access to instructions and registers.

Some potential advantages of blocking interrupts related to a disabled facility will now be discussed. Some interrupts (specifically, non-context changing interrupts) change only the instruction sequence executed, but do not: (i) change the program context (for example, privilege level, priority, address translation, available facilities, etc.); or (ii) replace the user application that is currently executing. Non-context-changing interrupts only occur when the executing program is in the lowest privilege level. On the other hand, context-changing interrupts typically change the instruction sequence executed, but do at least one of the following: (i) change the program context; and/or (ii) replace the program that is currently executing (e.g. application or supervisor) with another program of a higher privilege level. Context-changing interrupts can occur at any privilege level.

Some embodiments of the present disclosure may include one, or more, of the following features, characteristics and/or advantages: (i) allow a hypervisor to fully disable a facility that can affect privilege levels other than only the lowest privilege level (for example, a performance monitor); (ii) allow a hypervisor to disable a performance monitor facility which can cause interrupts when the supervisor is running; (iii) avoid the need to have the hypervisor restore the context of the facility (for example, register values, etc.) prior to dispatching a supervisor program; and/or (iv) avoid the need for hypervisor to ensure that the registers of the facility were in a state such that they could not cause interrupts prior to enabling interrupts after an interrupt into the hypervisor (so the hypervisor would not get an unexpected interrupt).

In some embodiments of the present disclosure, some modules that intervene in other ways than by changing the instruction execution sequence, a processor control register or registers that control processor behaviors such as: (a) data cache size for each cache level (for example, fix the size at some default size regardless of a register that controlled its size—this affects only performance), (b) data cache replacement algorithm (for example, fix the algorithm to be some default algorithm regardless of the register that specified the algorithm—this affects only performance), (c) branch prediction method (for example, fix the method to be some default algorithm regardless of the register that specified the method—this affects only performance), (d) branch prediction history buffer depth used in predicting branches (for example, fix the history buffer depth used in predictions to be some default depth regardless of the register that specified the depth—this affects only performance); (e) program priority register (a register that affects program priority); (f) freezing of priority at some default regardless of the priority register value (again, this would affect only performance); (g) disabling a register that controls instruction fusion (for example, a processor might never (or always) fuse instructions regardless of a register the enabled fusion—fusion is the process of executing two consecutive instructions as if they were a single instruction); (h) disable a register that routes instructions in specific ways in the internal pipeline (for example, regardless of a register controlling routing, the processor might always route load/store instructions to the load/store unit even though they can also be executed in an arithmetic unit); and/or (i) branch history rolling buffer (BHRB) size (BHRB typically contains the addresses of most-recent branch instructions that were taken—for example, fix the size to a default regardless of a register specifying its size—the program could notice this, because it can check the size.)

In some embodiments, facilities capable of making performance-affecting interventions, such as those described in the previous paragraph, would enable a program to be restored without initializing the registers that controlled the behaviors.

With some facilities, an interrupt can only occur as a direct and immediate result of executing an instruction in the code of the executing program (that is. they are “instruction-caused interrupts” or “synchronous interrupts”). Thus if a facility, which is only capable of synchronous interrupts, is disabled, then the application cannot execute any instructions related to that facility and, consequently “synchronous interrupts” cannot occur. On the other hand, other facilities, because they generate interrupts as a direct immediate result of executing an instruction, and may generate an interrupt at any time (that is, “machine-caused interrupts” or “asynchronous interrupts”). Accordingly, some embodiments of the present invention may: (i) prevent asynchronous interrupts; and (ii) be unconcerned with preventing synchronous interrupts (because they are not a problem with respect to the initialization state of the executing program's control registers).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

First privilege level (of multiple privilege levels): any arbitrary privilege level of the multiple possible privilege levels; the first privilege level is not necessarily the level of highest privilege (although it could be) and it does not necessarily mean the level of lowest privilege (although it could also alternatively be that).

Intervening (with respect to): interrupting and/or otherwise interfering; sometimes herein used to describe situations where facility(ies) are not allowed to “intervene with respect to” running program(s).

Interrupt: any unsolicited request made from a resource of a facility to an executing program that changes the order of execution of instructions of the program.

Context-changing request: any “interrupt” that changes context of an executing program in addition to changing instruction order; some possible types of context changes which may be made to a program by a context changing interrupt include (but are not necessarily limited to): privilege level, priority, address translation, available facilities, and/or replace the program that is currently executing (for example, application or supervisor) with another program of a higher privilege level.

Performance-affecting intervention: any “intervention” which does not change the order of execution of instructions of the executing program, but does impact performance (for example, execution speed, calculation accuracy).

What is claimed is:

1. A method for use with a computer system including a plurality of resources and a processor(s) set including a plurality of control registers, the method comprising:
starting to run a program;
in response to starting to run the program, controlling initialization of control registers of the plurality of control registers that are associated with the program so that at least some of the control registers do not immediately initialize in direct response to the starting of the running of the program;
receiving, from a first resource of the plurality of resources, an attempt to make a context-changing interrupt with respect to the program;
determining whether the attempted context-changing interrupt by the first resource would involve control registers associated with the program that have not been initialized; and
in response to a determination that the attempted context-changing interrupt would involve control registers that have not been initialized, preventing, by machine logic, the attempted context-changing interrupt from proceeding.

2. The method of claim 1 wherein the program starts to run at a privilege level other than the lowest privilege level.

3. The method of claim 1 further comprising:
in response to a determination that the attempted context-changing interrupt would not involve control registers that have not been initialized, allowing the attempted context-changing interrupt to proceed.

4. The method of claim 1 wherein the attempted context-changing interrupt is designed to change context in at least one of the following types of context: privilege level, priority, address translation, available facilities, and/or replace the executing program.

5. The method of claim 1 wherein the attempted interrupt is an asynchronous interrupt.

6. The method of claim 1 wherein the prevention, by machine logic, of the attempted context-changing interrupt includes disabling the associated resource until control registers required by that resource have been initialized.

7. A computer program product comprising:
a storage device structured and/or programmed to store machine readable data in a manner that is not transitory in the way that a signal in transit is transitory;
data stored on the storage device, including respective sets of machine readable instructions respectively programmed to cause a set of processor(s) to perform the following actions:
start to run a program,
in response to starting to run the program, control initialization of control registers of the plurality of control registers that are associated with the program so that at least some of the control registers do not immediately initialize in direct response to the starting of the running of the program,
receive, from a first resource of the plurality of resources, an attempt to make a context-changing interrupt with respect to the program,
determine whether the attempted context-changing interrupt by the first resource would involve control registers associated with the program that have not been initialized, and
in response to a determination that the attempted context-changing interrupt would involve control registers that have not been initialized, prevent, by machine logic, the attempted context-changing interrupt from proceeding.

8. The computer program product of claim 7 wherein the set of machine readable instructions programmed to start to run a program are further programmed to start to run at a privilege level other than the lowest privilege level.

9. The computer program product of claim 7 wherein the data stored on the storage device further includes a further set of machine readable instructions programmed to cause a computer system to:
in response to a determination that the attempted context-changing interrupt would not involve control registers that have not been initialized, allow the attempted context-changing interrupt to proceed.

10. The computer program product of claim 7 wherein the attempted context-changing interrupt is designed to change context in at least one of the following types of context: privilege level, priority, address translation, available facilities, and/or replace the executing program.

11. The computer program product of claim 7 wherein the attempted interrupt is an asynchronous interrupt.

12. The computer program product of claim 7 wherein the set of machine readable instructions programmed to prevent the context-changing interrupt are further programmed to effect the prevention by disabling the associated resource until control registers required by that resource have been initialized.

13. The computer program product of claim 7 further comprising:
a set of processor(s) is structured and/or programmed to perform the actions corresponding to the sets of machine readable instructions, and includes the control registers.

14. A method for use with a computer system including a plurality of resources and a processor(s) set including a plurality of control registers, the method comprising:
starting to run a program;
in response to starting to run the program, controlling initialization of control registers of the plurality of control registers that are associated with the program so that at least some of the control registers do not immediately initialize in direct response to the starting of the running of the program;
subsequent to the control of initialization of control registers so that at least some of the control registers do not immediately initialize, initializing the at least some of the control registers; and
controlling, by machine logic included in a processor(s) set, a first facility included in the processor(s) set so that the first facility does not attempt to make a performance-affecting intervention in the running of the program until after initialization of the at least some of the control registers, with a performance-affecting intervention being defined as any “intervention” which: (i) does not change the order of execution of instructions of the program, and (ii) does impact performance of the program.

15. The method of claim 14 wherein the first facility is a data stream control register (DSCR).

16. The method of claim 14 wherein the performance-affecting intervention will, if allowed, affect execution speed.

17. The method of claim 14 wherein the performance-affecting invention will, if allowed, affect at least one of the following characteristics and/or actions: data cache size, data cache replacement algorithm, branch prediction method, branch prediction history buffer depth, program priority register, freezing of priority at some default regardless of the priority register value, disabling a register that controls instruction fusion, routing of instructions in specific ways in an internal pipeline, and/or branch history rolling buffer (BHRB) size.

18. The method of claim 14 wherein the program starts to run at a privilege level other than the lowest privilege level.

19. The method of claim 14 wherein the program starts to run at the lowest privilege level.

20. The method of claim 14 further comprising:
controlling, by machine logic included in a processor(s) set, the first facility included in the processor(s) set so that the first facility does make a performance-affecting intervention(s) in the running of the program after initialization of the at least some of the control registers.
